(19) United States
(12) Patent Application Publication
(10) Pub. No.: US 2016/0210878 A1
(43) Pub. Date: Jul. 21, 2016

(54) METHODS AND KITS FOR EDUCATING INDIVIDUALS ABOUT THE CUSTOMS AND TRADITIONS ASSOCIATED WITH CHRISTMAS

(71) Applicant: Richard Anthony Schreiber, Germantown, TN (US)

(72) Inventor: Richard Anthony Schreiber, Germantown, TN (US)

(21) Appl. No.: 14/602,219

(22) Filed: Jan. 21, 2015

(51) Int. Cl. G09B 19/00; G09B 5/06

(52) U.S. Cl. CPC G09B 19/0046; G09B 5/06

(57) ABSTRACT

Methods and kits comprising providing one or more candy canes; providing a penetrable form that resembles a Christmas tree, wherein the candy canes can be inserted into the penetrable form with minimal force; providing one or more media containing information relating to customs and traditions associated with Christmas; inserting one or more candy canes into the penetrable form; and conveying the media information to one or more individuals at about the same time that the one or more candy canes are inserted into the penetrable form, thereby educating the individuals about the customs and traditions associated with Christmas, are provided.

### CROSS REFERENCE TO RELATED APPLICATIONS

This application claims priority to U.S. Provisional Application Ser. No. 61/55,593,812 filed Jan. 23, 2014, the disclosure of which is incorporated herein by this reference.

### BACKGROUND OF THE INVENTION

1. Field of the Invention

The invention relates generally to educational methods and kits and particularly to methods and kits for educating individuals about the customs and traditions associated with Christmas.

2. Description of Related Art

Christmas is an important holiday for many individuals, particularly Christians. Celebrating the birth of Jesus Christ often takes on a special significance that is accompanied by many customs and traditions, e.g., exchanging Christmas cards, exchanging presents, and counting down the 12 days before Christmas. In addition, those celebrating Christmas often use various devices to remind themselves and others of the significance of the holiday and the various customs and traditions used to celebrate the holiday. For example, Christmas stockings are hung on the fireplace, mistletoe is hung in the home, and children visit Santa Claus to request presents.

One of the most significant such custom and tradition is to erect and decorate a Christmas tree. However, the origin of this custom and tradition is unclear. Many stories about the origin of the Christmas tree are known. The origin of the Christmas tree has several interesting stories that tell the story of how the Christmas came to symbolize Christmas. For example, one such story is about a famous hawthorn called the “Holy Thorn” that was found at Glastonbury Abbey in England and flowers at Christmas time. It was venerated as a “sacred relic” because a legend claims that it derived from a sprig that came from Jesus' crown of thorns. Another relates the story that when Christ was born in the dead of winter, every tree throughout the world miraculously shook off its ice and snow and produced new shoots of green. Still another tells the story that Christmas trees started with medieval plays. In these plays, dramas depicting biblical themes began as part of the church's worship. However, by the late Middle Ages, the dramas had become rowdy and were dominated by laypeople. The plays celebrating the Nativity were linked to the story of creation mainly because Christmas Eve was also considered the feast day of Adam and Eve. Thus, as part of the play, the Garden of Eden was symbolized by a Christmas tree hung with fruit. Many such customs and traditions are known.

Another significant such custom and tradition is to place candy canes on Christmas trees. The origin of this custom and tradition is also unclear. Several stories about how the candy canes are associated with Christmas are known, e.g., “The Legend of the Candy Cane.”

There are, however, very few if any methods and devices for educating individuals about the customs and traditions associated with Christmas. There are numerous methods and devices known in the art that help individuals celebrate Christmas. For example, US20120219732 discloses an artificial Christmas tree connection structure having a branch connection base and branch shaft units. US20120120637 discloses Christmas tree scene systems that provide a holiday decorating assembly having a mounting surface with at least one receiving aperture, at least one mounting dowel, a plurality of figurines, electrical wiring, and LED illuminators. U.S. Pat. No. 8,025,295 discloses a Christmas tree game that permits the players to build a Christmas tree using branches. U.S. Pat. No. 7,513,502 discloses a story telling game having a spinner wheel divided into sections imprinted with instructions such as “serve guests” and a related story. U.S. Pat. No. 7,494,127 discloses a game for stimulating imagination and creativity in a plurality of players by story telling. The game involves a player selecting a given number of photo cards depicting a discrete scene place or object and using one or more of the selected cards to tell a story. U.S. Pat. No. 6,861,108 discloses methods, apparatus, and kits that provide a new market for artificial flowers presently sold only as part of artificial plant assemblies. U.S. Pat. No. 5,871,214 discloses hook and loop decoration games for combining a game with decorations for holidays. U.S. Pat. No. 4,428,988 discloses illuminated ornamental structures that are easily assembled and disassembled having light transmitting components that may be packaged as a kit and subsequently erected to provide a simulated illuminated Christmas tree. U.S. Pat. No. 5,389,028 discloses an integrally formed Christmas stocking and puppet in combination with a story media sized to be contained within the open-ended cavity of the Christmas stocking. U.S. Pat. No. 509,041 discloses an ornamental design for a combined candy cane and stocking. U.S. Pat. No. 467,701 discloses an ornamental design for a character candy cane. Mostly, any teaching or educating about such customs and traditions occurs when the customs or traditions are related orally from one individual to another, e.g., in a story or song; are related visually, e.g., a movie or videotape; or are related when reading printed material, e.g., a book. There is, therefore, a need for novel methods and devices for educating individuals about the customs and traditions associated with Christmas.

### SUMMARY OF THE INVENTION

It is, therefore, an object of the invention to provide methods for educating individuals about the customs and traditions associated with Christmas.

It is another object of the invention to provide articles of manufacture in the form of kits containing objects useful for educating individuals about the customs and traditions associated with Christmas.

It is a further object of the invention to provide a means of communicating information about or instructions for educating individuals about the customs and traditions associated with Christmas.

These and other objects of the invention are achieved through the use of methods and kits that involve (1) providing one or more candy canes; (2) providing a penetrable form that resembles a Christmas tree, wherein the candy canes can be inserted into the penetrable form with minimal force; (3) providing one or more media containing information relating to customs and traditions associated with Christmas; (4) inserting one or more candy canes into the penetrable form; and (5) conveying the media information to one or more individuals at about the same time that the one or more candy canes are inserted into the penetrable form, thereby educating the individuals about the customs and traditions associated with Christmas. The methods and kits are generally used to educate individuals about the customs and traditions associated with Christmas by providing an interactive environment that makes learning fun and easy.

Other and further objects, features, and advantages of the present invention will be readily apparent to those skilled in the art.

This summary is provided to introduce a selection of concepts in a simplified form that are further described below in the detailed description of the invention. This summary is not intended to identify key features or essential features of the claimed invention nor is it intended to be used to limit the scope of the claimed invention.

### DETAILED DESCRIPTION OF THE INVENTION

In one aspect, the invention provides methods for educating one or more individuals about the customs and traditions associated with Christmas. The methods comprise (1) providing one or more candy canes; (2) providing a penetrable form that resembles a Christmas tree, wherein the candy canes can be inserted into the penetrable form with minimal force; (3) providing one or more media containing information relating to customs and traditions associated with Christmas; (4) inserting one or more candy canes into the penetrable form; and (5) conveying the media information to one or more individuals at about the same time that the one or more candy canes are inserted into the penetrable form.

The candy canes useful in the invention are any candy canes known in the art. Generally, the candy canes are red and white stripped candy canes having a total length of from about 1 to about 12 inches, preferably from about 2 to about 8 inches, and a total width of from about 0.1 to about 1 inch, preferably from about 0.1 to about 0.5 inches. In some embodiments, the candy canes are white with no stripes. Generally, the candy canes have any color or pattern. Candy canes have a cane shape known to skilled artisans. The candy canes can be plain as typically available or can be ornamental if desired.

The penetrable form useful in the invention is made from any material that is penetrable by a candy cane shaft using minimal force, e.g., the force generated by a child pushing on the candy cane while trying to insert its shaft in into the penetrable form, or any material that can be drilled to produce a hole that can accept and retain the candy cane shaft when inserted into the hole using such minimal force, or combinations thereof. Typically, the materials are Styrofoam, paper, clay, wood, ceramic, plastic, and the like. However, the materials can be metal, glass, and the like.

The penetrable form is made by forming or shaping the materials into a form that resembles a Christmas tree. The materials can be formed or shaped using any suitable method, e.g., molding, blow molding, cutting, carving, slicing, sawing, rasping, and the like. Methods for shaping and forming such materials are known in the art.

The penetrable from is any size useful for the invention but is preferably from about 6 inches to about 6 feet tall, preferably from about 9 inches to about 3 feet tall.

The media useful in the invention are any media suitable for conveying to individuals information about the customs and traditions associated with Christmas. Suitable media include printable materials such as paper, audio recorders such as tape recorders and digital recorders, and video recorders such as video cameras. In many embodiments, the media is simply paper or plastic cards containing printed information. In others, the media is a computer, video player, tablet, or smartphone having recorded audio and/or video information. In some embodiments, the audio or video information is obtainable using a computer, tablet, smart phone, or similar device as needed via connection via the internet, using a phone data plan, and the like.

The information useful in the invention is any information now or hereafter available relating to customs and traditions associated with Christmas, e.g., the legend of the candy cane, the legend of the Christmas tree, the history of the Christmas tree, and the like.

In various embodiments, the candy canes are inserted into the penetrable form by placing the candy cane shaft against the penetrable form and applying sufficient pressure to cause the candy cane shaft to penetrate the form or by creating a hole in the penetrable form and inserting the candy cane into the hole as described herein. When the penetrable form is made from relatively non-penetrable materials such as wood or plastic, a hole is made in the penetrable form and the candy cane is inserted into the hole. When the penetrable form is made from relatively penetrable materials such as Styrofoam or clay, the candy cane can be directly inserted into the penetrable form. The force required to insert the candy cane into the penetrable form or the hole is any amount of force required to cause the candy cane shaft to penetrate the surface of the penetrable form and enter the form, e.g., by at least one eighth of an inch. Typically, the force will cause the candy cane shaft to penetrate into the penetrable form by from about 0.5 to about 3 inches.

Generally, the information is conveyed using any suitable means. In some embodiments, the information is conveyed using one or more printed materials having a story about a custom or tradition printed on the materials, e.g., cards, paper sheets, or posters. Immediately following insertion of the candy cane, the story is read to the individuals. In other embodiments, the information is conveyed using one or more media having the story recorded orally on the media Immediately after inserting the candy cane, the story is played for listening by individuals. In further embodiments, the information is conveyed using one or more media having the story recorded on the media for viewing Immediately after inserting the candy cane, the story is played for viewing and listening by individuals. The information can be recorded on any appropriate device, e.g., tape recorders, digital recorders, CDs, videotape, computers, tablets, smart phones, and the like. In another embodiment, the information is conveyed by having a consumer view a webpage containing the information and conveying the information on the website to the individuals, e.g., by reading the information aloud, playing an audio recording on the webpage, playing a video recording on the webpage, having one or more individuals read the information (aloud or silently), and the like. In a preferred embodiment, the consumer views the webpage by scanning a bar code or similar device with a smartphone, tablet, or similar device to facilitate accessing the webpage.

In certain embodiments, the methods further comprise repeating step (4) and step (5) daily for one or more days before Christmas.

In certain embodiments, the methods further comprise creating one or more preformed holes in the penetrable form before inserting the one or more candy canes into the penetrable form, the holes having a size and shape that facilitates insertion of the candy cane into the penetrable form. The holes can be made when the penetrable form is manufactured or can be made after manufacture but before the candy canes are inserted. The holes can be made using any suitable device, e.g., a metal rod, a glass rod, a ceramic rod, a plastic rod, a wood rod, a drill bit, a pencil, and the like. The device can be sharpened to facilitate making the holes or unsharpened. When inserting more than one candy cane, the various holes and corresponding candy canes can be the same size and shape or a different size and shape provided that the size and shape of a hole matches the size and shape of the corresponding candy cane.

In certain embodiments, the methods further comprise providing one or more top ornaments that can be reversibly or irreversibly attached to the top of the penetrable form and attaching the top ornament to the top of the penetrable form. The top ornaments are designed to have a Christmas theme and provide decoration for the penetrable form to further ensure that the penetrable form resembles a Christmas tree.

The top ornaments useful in the invention are any ornaments that can be reversibly or irreversibly attached to the top of the penetrable form. Preferably the ornaments are made from ceramic, plastic, metal, Styrofoam, wood, paper, and the like and are designed to have a Christmas theme, e.g., a star. Typically, the top ornament is attached to the top of the penetrable form using any suitable means, e.g., an ornament base shaped to match the top of the penetrable form (a cone or coil that conforms to the shape of the top of the penetrable form) or a spike.

In certain embodiments, the methods further comprise providing one or more support bases that can be reversibly or irreversibly attached to the bottom of the penetrable form and attaching the support base to the bottom of the penetrable form. The support base, when required, provides support for the penetrable form and helps ensure that the penetrable form remains upright when the bottom is oriented toward a surface. The support base helps prevent the penetrable form from tipping over or being easily knocked over. In some embodiments, the penetrable form is shaped so that it is unlikely to tip over or be knocked over and therefore does not need a support base.

The support bases useful in the invention are any support bases that can be reversibly or irreversibly attached to the bottom of the penetrable form. Preferably the support bases are made from ceramic, plastic, metal, wood, Styrofoam, paper, and the like and are designed to keep the penetrable form from tipping over, whether alone, with inserted candy canes, with ornaments, or with a combination of candy canes and ornaments. In certain embodiments, the support base is a plus shaped wood or plastic design that attaches to the penetrable form via an insertable spike. Typically, the penetrable form resembling a Christmas tree is oriented with its bottom on a surface and its top pointed upward. If a support base is required or wanted, the penetrable from is attached to the base and the base is placed on the surface.

In illustrative embodiments, one or more candy canes are inserted into the penetrable form by placing the candy cane shaft against the penetrable form and applying sufficient pressure to cause the candy cane shaft to penetrate the form or by creating a hole in the penetrable form and inserting the candy cane into the hole. Then, a custom or tradition associated with Christmas is conveyed to individuals, typically individuals that participated in or observed the insertion of the candy cane into the penetrable form. In one preferred embodiment, the custom or tradition is the The Legend of the Candy Cane. In another preferred embodiment, the custom or tradition is the The Legend of the Christmas Tree.

In other illustrative embodiments, beginning on a certain number of days before Christmas day, e.g., 12 days before Christmas day, one or more candy canes are inserted into the penetrable form by placing the candy cane shaft against the penetrable form and applying sufficient pressure to cause the candy cane shaft to penetrate the form or by creating a hole in the penetrable form and inserting the candy cane into the hole. Then, a custom or tradition associated with Christmas is conveyed to individuals, typically individuals that participated in or observed the insertion of the candy cane into the penetrable form. This process of inserting one or more candy canes into the penetrable form and conveying a custom or tradition associated with Christmas to individuals is repeated at least once daily until Christmas day. The individuals participating in the process are educated about the customs and traditions associated with Christmas.

In a typical situation, a consumer purchases a kit containing a plurality of candy canes, a penetrable form that resembles a Christmas tree, and one or more media that contains information about a custom or tradition associated with Christmas. The kit may optionally contain an ornament, a base, a device for creating holes in the penetrable form, or any other object that facilitates use of the kit. Then, the consumer's family gathers around the penetrable form; a child inserts one or more candy canes into the penetrable form, directly or in a hole created for the candy cane; and an adult family member conveys one or more customs or traditions associated with Christmas, preferably ones that convey a message about Jesus Christ, the Christmas tree, the candy cane, or a combination thereof. The process of inserting the candy canes into the penetrable form and conveying customs or traditions associated with Christmas can be repeated daily for as many days as the consumer desires.

In a further aspect, the invention provides kits suitable for educating one or more individuals about the customs and traditions associated with Christmas. The kits comprise in separate containers in a single package or in separate containers in a virtual package, as appropriate for the kit component, a penetrable form that resembles a Christmas tree and one or more of (1) one or more candy canes; (2) one or more media containing information relating to customs and traditions associated with Christmas; (3) one or more top ornaments that can be reversibly or irreversibly attached to the top of the penetrable form; (4) one or more support bases that can be reversibly or irreversibly attached to the bottom of the penetrable form; (5) one or more devices suitable for creating a hole in the penetrable form; (5) instructions for how to use the device to create one or more holes in the penetrable form; (7) instructions for how to assemble the kit components; and (8) instructions for how to use the kit components to educate one or more individuals about the customs and traditions associated with Christmas.

When the kit comprises a virtual package, the kit contains the penetrable form and one or more of the other physical components, e.g., the candy canes, but the media is a virtual media that contains the information relating to customs and traditions associated with Christmas, e.g., a viewable webpage containing information relating to customs and traditions associated with Christmas and/or instructions relating to the kit and its assembly and use.

In some embodiments of the kit, the penetrable form is accompanied by a set of printed materials having a story about a custom or tradition printed on the materials, e.g., cards, paper sheets, or posters Immediately following insertion of a candy cane into the penetrable form, the story is read to the individuals. In other embodiments, the penetrable form is accompanied by one or more media having the story recorded orally on the media. Immediately after inserting one or more candy canes, the story is played for listening by individuals. In further embodiments, the penetrable form is accompanied by one or more media having the story recorded for viewing visually on the media Immediately after inserting one or more candy canes, the story is played for viewing and listening by individuals. The story can be recorded on any appropriate device, e.g., tape recorders, digital recorders, CDs, videotape, computers, tablets, smart phones, and the like. In these embodiments, the consumer can purchase the candy canes or other components separately or they could be included in the kit.

The term “single package” means that the components of a kit are physically associated in or with one or more containers and considered a unit for manufacture, distribution, sale, or use. Containers include, but are not limited to, bags, boxes, cartons, packages of any type or design or material, over-wrap, shrink-wrap, affixed components (e.g., stapled, adhered, or the like), or combinations thereof. A single package may be containers of individual components of the invention physically associated such that they are considered a unit for manufacture, distribution, sale, or use.

The term “virtual package” means that the components of a kit are associated by directions on or with one or more physical or virtual kit components instructing the user how to obtain the other components, e.g., a bag or other container containing one component and directions instructing the user to go to a website, contact a recorded message or a fax-back service, view a visual message, or contact a business to obtain instructions on how to use the kit or to obtain safety or technical information about one or more kit components. Examples of information that can be provided as part of a virtual kit include assembly instructions, use instructions, contact information, and safety information.

In another aspect, the present invention provides a means for communicating information about or instructions for educating one or more individuals about the customs and traditions associated with Christmas using the methods and kits of the invention. The communicating means comprises a document, digital storage media, optical storage media, audio presentation, or visual display containing the information or instructions. Preferably, the communication is a webpage, webpage element, brochure, product label, advertisement, or visual display containing such information or instructions. More preferably, the communication is a displayed webpage or a popup window or web frame on a displayed webpage. Useful information includes one or more of (1) information about the customs and traditions associated with Christmas, (2) the benefits and advantages of using the methods and kits of the invention to educate individuals about the customs and traditions associated with Christmas, and (3) contact information for consumers to use if they have a question about the kits and methods of the invention.

The methods, kits, and means for communicating are useful for educating one or more individuals about the customs and traditions associated with Christmas.

As used herein, the singular form of a word includes the plural, and vice versa, unless the context clearly dictates otherwise. Thus, the references “a”, “an”, and “the” are generally inclusive of the plurals of the respective terms. For example, reference to “a method” includes a plurality of such “methods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

Unless defined otherwise, all technical and scientific terms, terms of art, and acronyms used herein have the meanings commonly understood by one of ordinary skill in the art in the field(s) of the invention, or in the field(s) where the term is used.

In the specification, there have been disclosed typical preferred embodiments of the invention. Although specific terms are employed, they are used in a generic and descriptive sense only and not for purposes of limitation. The scope of the invention is set forth in the claims. Many modifications and variations of the invention are possible in light of the above teachings. It is therefore to be understood that within the scope of the appended claims, the invention may be practiced otherwise than as specifically described.

What is claimed is:

1. A method for educating one or more individuals about the customs and traditions associated with Christmas comprising:
(1) providing one or more candy canes;
(2) providing a penetrable form that resembles a Christmas tree, wherein the candy canes can be inserted into the penetrable form with minimal force;
(3) providing one or more media containing information relating to customs and traditions associated with Christmas;
(4) inserting one or more candy canes into the penetrable form; and
(5) conveying the media information to one or more individuals at about the same time that the one or more candy canes are inserted into the penetrable form.

2. The method of claim 1 further comprising repeating step (4) and step (5) daily for one or more days before Christmas.

3. The method of claim 1 further comprising creating one or more preformed holes in the penetrable form before inserting the one or more candy canes into the penetrable form, wherein the holes have a size and shape that facilitates insertion of the candy cane into the penetrable form.

4. The method of claim 1 further comprising providing one or more top ornaments that can be reversibly or irreversibly attached to the top of the penetrable form and attaching the top ornament to the top of the penetrable form.

5. The method of claim 1 further comprising providing one or more support bases that can be reversibly or irreversibly attached to the bottom of the penetrable form and attaching the support base to the bottom of the penetrable form.

6. The method of claim 1 wherein the candy canes are stripped, white, or combinations thereof.

7. The method of claim 1 wherein the penetrable form is Styrofoam, paper, clay, wood, ceramic, plastic, or combinations thereof.

8. The method of claim 1 wherein the penetrable form is Styrofoam.

9. The method of claim 1 wherein the media are printable materials, audio recordings, video recordings, or combinations thereof.

10. The method of claim 9 wherein the printable material is one or more cards.

11. The method of claim 1 wherein the media information is conveyed by viewing printable materials, reading printable materials, listening to audio recordings, viewing video recordings, or combinations thereof.

12. A kit suitable for educating one or more individuals about the customs and traditions associated with Christmas comprising in separate containers in a single package or in separate containers in a virtual package, as appropriate for the kit component, a penetrable form that resembles a Christmas tree and one or more of (1) one or more candy canes; (2) one or more media containing information relating to customs and traditions associated with Christmas; (3) one or more top ornaments that can be reversibly or irreversibly attached to the top of the penetrable form; (4) one or more support bases that can be reversibly or irreversibly attached to the bottom of the penetrable form; (5) one or more devices suitable for creating a hole in the penetrable form; (5) instructions for how to use the device to create one or more holes in the penetrable form; (7) instructions for how to assemble the kit components; and (8) instructions for how to use the kit components to educate one or more individuals about the customs and traditions associated with Christmas.

13. A kit of claim 12 wherein the penetrable form is Styrofoam, paper, clay, wood, ceramic, plastic, or combinations thereof.

14. A kit of claim 12 wherein the penetrable form is Styrofoam.

15. A kit of claim 12 wherein the candy canes are stripped, white, or combinations thereof.

16. The kit of claim 12 wherein the media are printable materials, audio recordings, video recordings, or combinations thereof.

17. The kit of claim 12 wherein the devices suitable for creating a hole in the penetrable form are metal rods, glass rods, ceramic rods, plastic rods, wood rods, or combinations thereof.

18. A means for communicating information about or instructions for educating one or more individuals about the customs and traditions associated with Christmas according to the method of claim 1, the means comprising a document, digital storage media, optical storage media, audio presentation, or visual display containing the information or instructions.

19. The means of claim 18 wherein the means is selected from the group consisting of a webpage, webpage element, brochure, product label, advertisement, or visual display containing such information or instructions.

20. The means of claim 18 wherein the means is selected from the group consisting of a displayed webpage, a popup window, and web frame on a displayed webpage.
